(19) United States
(12) Patent Application Publication
(10) Pub. No.: US 2006/0190147 A1
(43) Pub. Date: Aug. 24, 2006

(54) Driver-assist device, in particular, for parking a vehicle

(76) Inventors: Wei-Chia Lee, Leonburg (DE); Cyrille Bollengier, Gerlingen (DE)

Correspondence Address: KENYON & KENYON LLP, ONE BROADWAY, NEW YORK, NY, 10004, US

(21) Appl. No.: 10/563,664

(22) PCT Filed: May 18, 2004
(86) PCT No.: PCT/EP04/50836

§ 371 Date: Jan. 6, 2006

(30) Foreign Application Priority Data
Jul. 10, 2003 (DE) 10331235.8

(51) Int. Cl. G05D 1/00; G01C 22/00

(52) U.S. Cl. 701/26; 340/932.2; 701/28

(57) ABSTRACT

A device for driving assistance including an output unit for outputting driving instructions to a driver, in particular for parking into a parking space in which the driving instructions provide the driver with a driving zone situated between two trajectories inside which the driver may freely select a path into the parking space. He/she does not have to follow a single predefined ideal line, but still has the safety of not having to take a collision risk.

### FIELD OF THE INVENTION

The present invention relates to a device for driving assistance.

### BACKGROUND INFORMATION

A method for visualizing the travel path and an associated device are described in German Patent Application No. DE 199 25 584 A1 in which a travel path of a vehicle, to be anticipated and dependent on a set steering angle, is shown on a display. At least one section of the space to the rear of the vehicle is displayed. In addition, the display shows an area which is maximally reachable with the vehicle and which, at an intended maximum steering angle of the vehicle, may be reached in both directions. This provides the driver with information as to whether it is possible to back into a parking space visible on the display using a maximum steering angle. The driver is not guided. Moreover, conventional Park Pilots use ultrasonic sensors to measure the distance to obstacles and which alert the driver acoustically and/or visually to obstacles in the vehicle's proximity with the aid of a bar diagram, for example. Conventionally, a travel path to be selected by the driver on a display using pilot lines. During actual drive operation, a driver attempts to follow these pilot lines as accurately as possible. This may cause the driver to drive more accurately and thus more slowly than the actual space conditions require. Depending on a calculated travel path, it may also be necessary in particular to fully angle the steering wheel, even though the actual space conditions do not require a full steering angle. This may be critical in particular in tight spaces or when traffic is flowing in the opposite direction since, for example, a full steering angle could cause the vehicle front end to protrude into an adjacent driving lane. In order to reach a predefined steering angle, the driver may be requested to operate the steering wheel at a standstill, which may result in increased tire abrasion.

### SUMMARY

An example device for driving assistance according to the present invention may be advantageous in that two delimiting lines are calculated between which the driver is piloted, instead of a single setpoint trajectory which the driver is supposed to follow. The delimiting lines are characterized by trajectories including a tolerance zone which the driver must observe in order to park successfully. As long as the driver is within this zone, he/she may arbitrarily drive and steer and thus select any trajectory between the two delimiting trajectories without colliding with an obstacle. In order to remain in a safe zone, however, the driver may not leave the zone delimited by the trajectories. The trajectories are preferably selected in such a way that they may only be reached at an at least temporary maximum angle of the steering wheel. An unnecessary output of alert signals may possibly be. omitted as long as the driver remains in the zone delimited by the trajectories in which there is no risk of the vehicle colliding with obstacles. The driver may thus concentrate fully on the surrounding traffic situation. The driver is no longer forced to follow a narrow ideal line. As long as the space conditions allow it, full angles of the steering wheel may also be avoided.

It may be particularly advantageous to use a display for showing the vehicle's surroundings and for showing the calculated driving zone with respect to the shown surroundings of the vehicle. The driver is able to recognize the vehicle's surroundings in direct relation to the allowed driving zone represented by the delimiting trajectories.

It may be also advantageous to show an anticipated travel path of the vehicle on the display so that it is possible for the driver to compare the anticipated travel path of the vehicle to the displayed driving zone.

Moreover, it may be advantageous to select the trajectories which delimit the driving zone in such a way that, during the driving operation and in particular during a parking operation, they require one or possibly two full angles of the steering wheel. This means that a maximum steering angle of the vehicle on the way to the parking space is achieved when these trajectories are used. These trajectories thus define a driving zone predefined by the maximum steering angle of the vehicle.

It may also be advantageous to output an indication to the driver as to what extent he/she has to turn the steering wheel in order to drive on a more favorable course into the parking space. This indication relieves the driver from making a comparison between his/her travel path and the displayed driving zone and from possibly deriving corrections from this comparison.

Moreover, it may also be advantageous to provide the driver with a haptic output in the form of a powered impact on the steering wheel to point out that he/she is leaving the driving zone. In this way, the driver may noticeably and thus immediately be alerted to a possible collision.

### BRIEF DESCRIPTION OF THE DRAWINGS

Exemplary embodiments of the present invention are shown in the figures and are explained in greater detail below.

FIG. 1 shows a device for driving assistance in a motor vehicle according to an example embodiment of the present invention.

FIG. 2 shows a top view of a vehicle having a device for driving assistance during a parking operation according to an example embodiment of the present invention.

FIG. 3 shows a display demonstration of a device for driving assistance according to an example embodiment of the present invention displaying the calculated driving zone.

### DETAILED DESCRIPTION OF EXAMPLE EMBODIMENTS

An example device for driving assistance according to the present invention is used in particular in motor vehicles for parking operations. However, it may also be used in any other vehicle. Its use is not limited to parking operations, i.e., it may be used in any other, in particular challenging, driving situations requiring a comparably accurate piloting of the vehicle. Such a use may be, for example, negotiating the vehicle through a bottleneck in the roadway.

The device may be used for assisting a parking operation, for parking parallel, angular, or right-angled to the driving direction, as well as for backing into a parking space. Its use is particularly advantageous for backing into a parking space since visibility is generally poor for a driver in this instance so that a driver's need for assistance during a parking operation is particularly great. The example device for driving assistance according to the present invention is explained in the following, using the example of a backing operation into a parking space which is situated at the curb parallel to the course of the road. The example device for driving assistance according to the present invention is designed to be a Park Pilot for assisting during backing of the vehicle into the parking space.

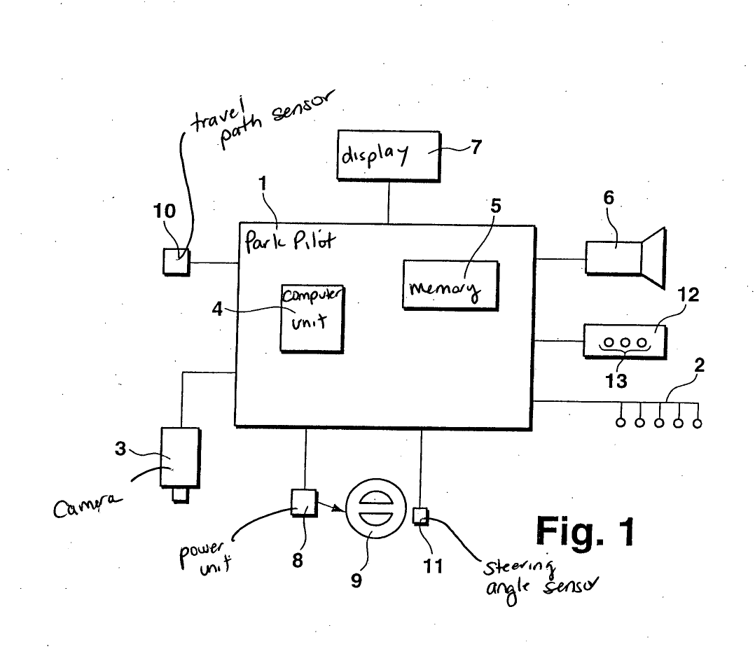

FIG. 1 shows a Park Pilot 1 which is installed in a vehicle. Park Pilot 1 has distance sensors 2 which are mounted on the vehicle front end and the vehicle rear end, as well as on the vehicle's side panels, and which measure the distance of the vehicle to obstacles in the vehicle's surroundings. Distance sensors 2 are designed as ultrasonic sensors, for example, and are used for distance determination via an echo time measurement of an ultrasonic signal reflected by an obstacle. Moreover, optical distance sensors, radar sensors for example, may be used for distance measurement.

Distance information determined by distance sensors 2 is processed in a computer unit 4. Computer unit 4 takes into account vehicle data stored in a memory 5. Among other things, the vehicle data indicates the position relationship of distance sensors 2 with respect to the vehicle exterior contour. As a function of the measured distance values, the vehicle's distance to obstacles in the vehicle's surroundings is determined by taking the vehicle data into account. If a predefined distance falls short, an acoustic alert via a speaker 6 and/or a visual alert via a display 7 is/are output to the driver. In a further embodiment, a power unit 8 may impact a steering wheel 9 of the motor vehicle in such a way that a driver also receives a haptic indication. A section of the vehicle's surroundings, the space in the rear of the vehicle, for example, may be monitored via a camera 3 and, if needed, may be shown to the driver on display 7.

According to the present invention, Park Pilot 1 is designed for the purpose of calculating trajectories for parking as a function of the surroundings data determined via distance sensors 2, starting from a current vehicle position to a park position. The current vehicle position, the position of obstacles, the vehicle dimensions—also the protrusion of the rear end, for example, when the steering wheel is turned—and the current steering angle, as well as the maximum steering angle, are taken into account in particular. Trajectories of the vehicle in which no collision occurs are determined in this context. To compensate for measuring uncertainty and an uncertainty in driving the vehicle, a minimum distance to the obstacles is preferably maintained which is taken into account in the calculation. This minimum distance is between 10 cm and 35 cm, 25 cm in a preferred embodiment.

A travel path sensor 10, which is able to determine a driving motion of the vehicle, is preferably used for determining the vehicle position. To determine a set steering angle, a steering angle sensor 11 is provided which monitors a turning motion of steering wheel 9. Control of Park Pilot 1 takes place via an operator's unit 12 which is equipped with keys 13. Activation of Park Pilot 1 may take place via operator's unit 12 in particular. Moreover, it is also possible to select an intended form of parking, e.g., parking parallel or perpendicular to the course of the road, or to change the parameters of Park Pilot 1, the vehicle data, for example. Park Pilot 1 is preferably mounted in a concealed location in the vehicle. In contrast, display 7 is situated in the center console of the vehicle or in a display instrument in front of the driver. A speaker 6 of a car radio, for example, may be used for acoustic output.

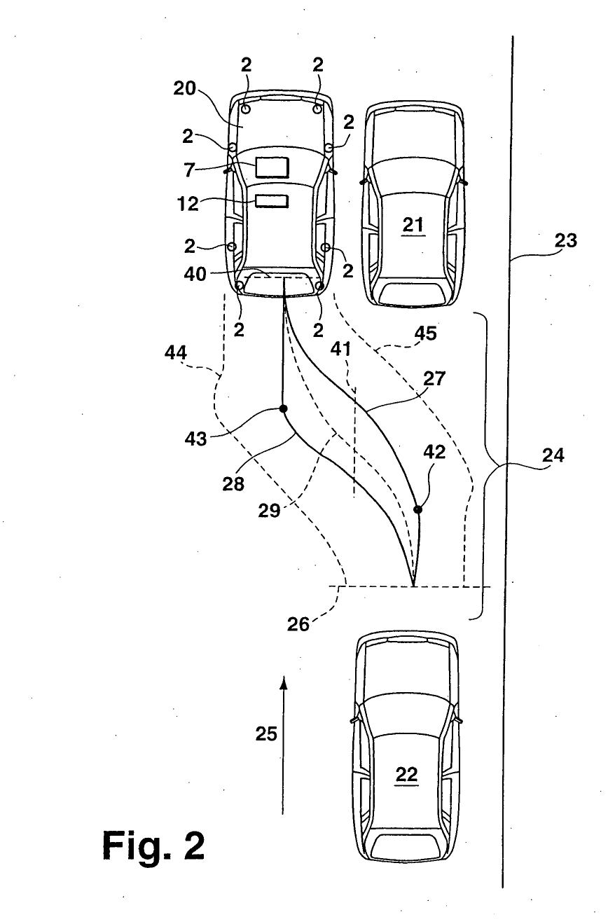

FIG. 2 shows a parking situation of a motor vehicle 20 including trajectories calculated according to an example embodiment of the present invention for piloting the vehicle into the parking space. Vehicle 20 is to be backed into a parking space between a first vehicle 21 and a second vehicle 22. Vehicles 21, 22 are both parked lengthwise at a curb 23. A distance exists between first vehicle 21 and second vehicle 22. The distance forms a parking space 24 between the two vehicles 21, 22 which is large enough to accommodate vehicle 20. Vehicle 20 traveled initially past second vehicle 22 in the direction of arrow 25, distance sensors 2, situated on the vehicle side facing curb 23, having measured parking space 24 in particular with respect to its length and preferably also with respect to its width. Based on this data and the also recorded positions of vehicles 21, 22, computer unit 4 calculates how vehicle 20 may be backed into parking space 24. Starting from the position of vehicle 20 shown in FIG. 2, there are multiple possible travel paths to reach an end position 26 for backing into parking space 24, it possibly being necessary to subsequently move vehicle 20 a short distance forward from end position 26. A parking space generally offers enough room that more than one travel path from the current vehicle position leads to a suitable park position without collision while observing a minimum distance from obstacles.

FIG. 2 shows a first extreme trajectory 27 and a second extreme trajectory 28. One trajectory should indicate the vehicle's travel path, which is described in the present embodiment by the path along which the center of the vehicle's rear axle is guided during a move along the trajectory. Rear axle 40 of vehicle 20 is indicated in FIG. 2 by a dashed line. In addition to this definition of a trajectory, a travel path of the vehicle may also be defined via other, fixed points of the vehicle, e.g., at the corners of the vehicle contour or at the position of the wheels.

The vehicle dimensions are observed in calculating the two trajectories 27, 28 which thus indicate two different travel paths. The vehicle, for example, might overreach or protrude on the sides beyond the width of the wheels, with mirrors, for example. The trajectories may thus be selected only in such a way that, under consideration of these edge areas, the vehicle is not able to collide with obstacles alongside the vehicle.

In first trajectory 27, a steering wheel of vehicle 20 is initially fully angled in the direction of the parking space. After a certain driven distance, it is necessary to fully angle the steering wheel in the other direction. This turnaround area is indicated by a dashed line 41 which also cuts across second trajectory 28. After the vehicle has moved adequately into parking space 24, the driver must simply back up straight from a point 42 onward until end position 26 is reached.

Second trajectory 28 is established in such a way that, when piloted along second trajectory 28, the vehicle initially backs up straight to a point 43. The steering wheel is fully angled in the direction of parking space 24 at this point. When the turnaround area (dashed line 41) is reached, the steering wheel is fully angled in the opposite direction

Both trajectories 27, 28 make collision-free parking possible. This is made clear by dashed lines 44, 45 which delimit an area occupied by the vehicle during travel, that area lateral to vehicle 20 not being exceeded during travel along both trajectories. The dashed lines neither run toward the curb, nor do they fall below a preferably predefined safety distance to vehicles 21, 22. Both trajectories describe extreme, differing travel paths: In the second trajectory, the steering wheel may no longer be slightly angled beyond point 43; in the first trajectory, the steering wheel may no longer be slightly angled in the opposite direction before point 42. In order to reach the indicated end position 26 of the vehicle, the driver may select any trajectory for the parking operation which lies between first and second trajectory 27, 28. Emphasized by a dashed line is an ideal line 29 in which no full steering angle is necessary, neither in the first steering direction nor in the opposite steering direction, and which has a maximum distance to both delimiting trajectories 27, 28. Since each trajectory enclosed by trajectories 27, 28 results in the parking of vehicle 20 into parking space 24, it is not absolutely necessary for the driver to follow ideal line 29. This rather represents driver concentration and driving effort which needlessly stresses the driver. It is sufficient to ensure that the driver and his/her vehicle move within delimiting trajectories 27, 28.

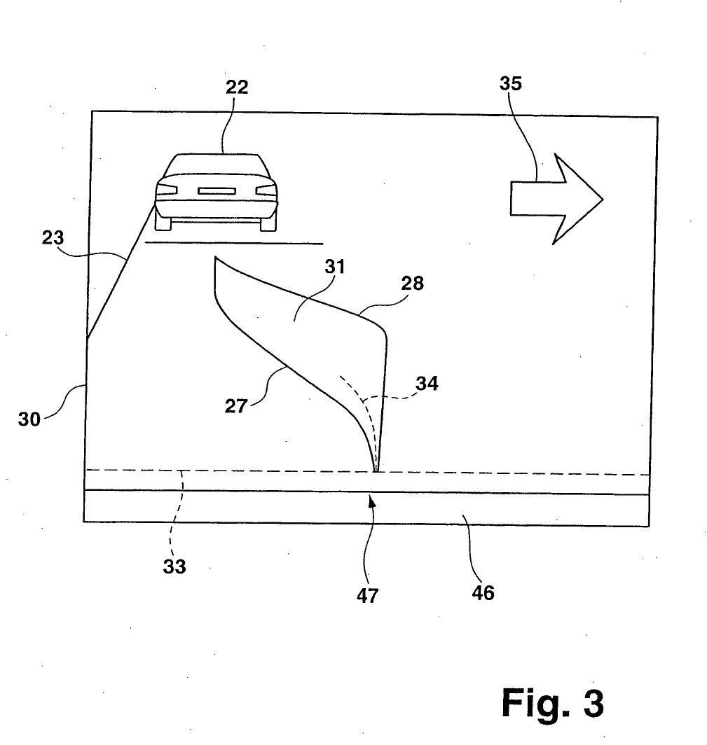

In a first example embodiment according to the present invention, display 7 shows the driver an area which is situated between both extreme trajectories 27 and 28. Such a display is subsequently explained on the basis of FIG. 3. It is sufficient for the driver to move the vehicle within the area delimited by trajectories 27, 28, i.e., to steer the vehicle in such a way that it moves with its center of the rear axle within this delimited area.

Since the driver no longer has to follow ideal line 29 but may rather move within the entire and thus wider area, parking may take place at a higher speed vis-à-vis following ideal line 29. However, since trajectories 27, 28 run toward each other when end position 26 of the parking operation is approached, it may be necessary, when increasingly approaching the final park position, to reduce the vehicle speed in order to orientate oneself in the increasingly narrower area. A corresponding alert may be output to the driver on display 7.

It is also possible in another exemplary embodiment that an output of indications to the vehicle driver occurs only until a maximum oblique state between the vehicle and the position of the vehicle in the parking space is reached. The angle between the longitudinal axis of vehicle 20 and parked vehicles 21, 22 is known as a yaw angle. A vehicle is thus piloted only until the maximum yaw angle is reached. In the following it is the task solely of the driver to reduce this yaw angle to zero and to move the vehicle into the park position. Corresponding assistance for the driver in the form of a displayed driving zone during the reduction may be dispensed with since he/she may carry out this reduction him/herself if needed.

FIG. 3 shows an exemplary embodiment for a display demonstration 30 on display 7. A camera device (not shown in FIG. 2) may record an image of the driving zone behind the rear end of vehicle 20, for example. Instead of determining the vehicle's surroundings via the camera device, it also possible to arithmetically generate a surroundings map of vehicle 20 via the analysis of distance sensors 2. According to the illustration in FIG. 2, a calculated display demonstration may also take place in a top view.

In display demonstration 30, second vehicle 22 and curb 23 are depicted in the image recorded by camera 3. In addition, a driving zone 31 is shown which is delimited by both trajectories 27, 28. Trajectories 27, 28 are arithmetically projected onto the travel path into the parking space, i.e., onto the road surface, and are inserted into display demonstration 30.

In order to drive into parking space 24, a driver pilots the vehicle in such a way that the center of the rear axle is guided within driving zone 31. In a first example embodiment, a travel path marker 34 is displayed on the display demonstration. Travel path marker 34 indicates a projected travel line which is dependent on the current steering angle position. Travel path marker 34 describes the path of the rear axle's center which it assumes when the vehicle is backed up at an unchanged steering angle position. A current steering angle position is determined via steering angle sensor 11. Travel path marker 34 is displayed for a certain distance, e.g., for a distance of 2m starting from a current vehicle position. By comparing travel path marker 34 to trajectories 27, 28, the driver may recognize if and when a steering intervention is necessary. If travel path marker 34 is situated within driving zone 31, the driver may drive into the parking space without a collision risk and without having to execute a steering angle correction.

In another example embodiment, a center marker 47 may be provided which indicates the center of the vehicle in display demonstration 30. In order to give the viewer a better perspective, at least one outer edge of the bumper of vehicle 20 is inserted into display demonstration 30.

A stop marker 32 is shown in a preferred embodiment which indicates to the driver at what point he/she must stop before second vehicle 22. It is provided in another preferred embodiment to display a start marker 33 up to which a driver must back up straight and parallel to first vehicle 21, in order to subsequently begin angling the steering wheel for parking in the parking space. In an embodiment not shown in FIG. 3, ideal line 29 may also be displayed in driving zone 31 for additional perspective.

If a change in the steering direction by the driver is necessary or advisable, such a change in direction may be indicated separately on display demonstration 30 in a particular embodiment, by displaying an appropriate arrow symbol, for example. An arrow 35, for example, which indicates the steering direction to the driver in which a correction should be made, is displayed on display demonstration 30 for assisting the driver. In the present example, the driver should thus turn steering wheel 9 to the right.

Instead of or in addition to the described visual display, driving instructions may also be output to the driver via an acoustic and/or haptic output. In a haptic output, the steering wheel is easily turnable as long as the vehicle moves within driving zone 31. If the vehicle threatens to leave driving zone 31, i.e., to exceed trajectories 27, 28, steering wheel 9 either starts to vibrate and/or steering into a critical driving direction is made difficult.

Output may also occur acoustically in another embodiment, so that a driver is alerted, via a signal tone, for example, to the leaving of driving zone 31. No signal means that the driver is within previously calculated driving zone 31.

By monitoring the traveled distance using travel path sensor 10 and steering angle sensor 11, computer unit 4 traces to which extent vehicle 20 follows the suggested driving zone 31. If needed, trajectories 27, 28 and thus driving zone 31 are dynamically adjusted as a function of the position of the vehicle or the changed distances to the obstacles.

1-9. (canceled)

10. A device for driving assistance for parking a vehicle, comprising:
an output unit for outputting driving instructions to a driver;
wherein the driving instructions provide a driver with a driving zone situated between two trajectories which are calculated in such a way that the vehicle can be moved within the driving zone.

11. The device for driving assistance as recited in claim 10, wherein the output unit includes a display configured to display surroundings of the vehicle and to display the driving zone with respect to the displayed surroundings of the vehicle.

12. The device for driving assistance as recited in claim 11, further comprising:
a detection unit configured to detect a set steering angle and to determine an anticipated travel path at an unchanged steering angle, the anticipated travel path being displayed at least partially with respect to the surroundings of the vehicle.

13. The device for driving assistance as recited in claim 10, wherein the trajectories delimiting the driving zone require at least one full angle of a steering wheel for following the appropriate trajectory.

14. The device for driving assistance as recited in claim 10, further comprising:
a measuring device configured to measure a distance of the vehicle to obstacles in the surroundings of the vehicle.

15. The device for driving assistance as recited in claim 10, further comprising:
a computer unit configured to determine a parking space suitable for the vehicle.

16. The device for driving assistance as recited in claim 10, wherein an indication for changing a turning direction of a steering wheel is output.

17. The device for driving assistance as recited in claim 10, further comprising:
a powered unit configured to impact a steering wheel of the vehicle for outputting a haptic effect via the steering wheel when leaving the driving zone.

18. The device for driving assistance as recited in claim 10, further comprising:
a speaker to output an acoustic alert signal when leaving the driving zone.
